(19) United States
(12) Patent Application Publication
(10) Pub. No.: US 2005/0242324 A1
(43) Pub. Date: Nov. 3, 2005

(54) Information recording method using light-induced surface relief

(76) Inventors: Takashi Fukuda, IBARAKI (JP); Hiroo Matsuda, Ibaraki (JP)

Correspondence Address: MORGAN LEWIS & BOCKIUS LLP, 1111 PENNSYLVANIA AVENUE NW, WASHINGTON, DC, 20004, US

(21) Appl. No.: 10/523,009

(22) PCT Filed: Aug. 1, 2003
(86) PCT No.: PCT/JP03/09812

§ 371 Date: Feb. 1, 2005

(51) Int. Cl. C09K 19/52

(52) U.S. Cl. 252/299.01

(57) ABSTRACT

The present invention is intended to raise the data density during the process which comprises irradiating a thin film of a polymer compound containing an azobenzene structure with light to form an unevenness pattern on the surface thereof, whereby data are recorded. When a thin azobenzene polymer film is irradiated with a linearly polarized circular laser beam or an ellipsoidal (or rectangular) laser beam having a band of light and darkness, a surface relief pattern characterized by portions by a number of k and raised portions by a number of (k+1) arranged alternately in a straight light is obtained. By making the use of the anisotropy of this pattern, a new data recording/reproducing method can be realized.

### TECHNICAL FIELD

The present invention relates to a method for irradiating the surface of a thin polymer compound film containing an azobenzene structure with light to form an anisotropic pattern of fallen and raised portions by which data are recorded or reproduced and a medium therefor.

### BACKGROUND ART

A phenomenon of formation of a relief (uneven surface) on the surface of a thin polymer film having an azobenzene site upon irradiation with light (light-induced surface relief) has become of strong interest since it was reported in 1995 (see the following Non-patent References 1 and 2).

This phenomenon is attributed to a process that when a thin film of a polymer compound containing an azobenzene structure is irradiated with a light pattern, the surface of the thin film reacts to the intensity of light to cause the molecule to move from a site having a higher light intensity to a site having a lwoer light intensity, resulting in the formation of uneven surface. Since the surface unevenness thus formed can be reased by furhter irradiatin with light having different wavelength or by heating, it has been planned to apply this phenomenon to high density optical data recording method, etc. by making the use of its capability of irreversibly forming rewritable hologram or light diffraction grating requiring no development process or accurately recording/reproducing the shape and polarized state of light beam.

### Non-Patent Reference 1

Appl. Phys. Lett., Vol. 66, (1995), pp136-138

### Non-Patent Reference 2

Appl. Phys. Lett., Vol. 66, (1995), pp1166-1168

### Patent Reference 1

The Unexamined Japanese Patent Application Publication No. 2002-74665

### Patent Reference 2

The Unexamined Japanese Patent Application Publication No. 2003-39400

### DISCLOSURE OF THE INVENTION

Under these circumstances, the present invention is worked out aiming at the enhancement of data density during the recording of data by the irradiation of a thin film of a polymer compound containing an azobenzene structure with light resulting in the formation of an unevenness pattern on the surface thereof.

When a thin azobenzene polymer film is irradiated with a linearly polarized circular laser beam having a Gaussian spatial distribution, a surface relief pattern characterized by one central depression (pit) and two portions which have a characteristic rise with respect to the direction of electric field vector of linear polarization is obtained as shown in FIG. 1. Alternatively, when the thin azobenzene polymer film is irradiated with an ellipsoidal (or rectangular) laser beam having a band of light and darkness as shown in FIG. 2, a surface relief pattern having fallen portions by a number of k and raised portions by a number of (k+1) arranged alternately in a straight light is obtained.

By making the use of the anisotropy of this pattern, a new data recording/reproducing method can be realized.

In recent years, the recording of optical data based on this phenomenon and the application of this phenomenon to active optical element, etc. have been studied (see, e.g., the above cited Patent References 1 and 2), but the amount of data is not yet sufficient.

### BRIEF DESCRIPTION OF THE DRAWINGS

FIG. 1 is a typical diagram of preparation of a pit by irradiation with converged laser beam.

FIG. 2 is a typical diagram of preparation of a line of pits by irradiation with a periodic optical pattern.

FIG. 3 is a diagram illustrating an AFM image of surface relief by condensed polarized beam.

FIG. 4 is a diagram illustrating the reading principle of recording method.

FIG. 5 is a diagram illustrating the relationship between the change of the intensity of reflection (or transmission) with the rotation of light read and the orientation of unevenness.

FIG. 6 is a diagram of change of reflectance (transmittance) with the depth of pit.

FIG. 7 is a diagram illustrating an AFM image of surface relief by irradiation with a periodic optical pattern and the relationship between the depth of surface relief and the intensity of signal.

FIG. 8 is a diagram illustrating an example (1) of optical system for the formation of periodic optical pattern.

FIG. 9 is a diagram illustrating an example (2) of optical system for the formation of periodic optical pattern.

### BEST MODE CARRYING OUT THE INVENTION

The data recording/reproducing method of the present application will be described in connection with the drawings.

### Embodiment 1

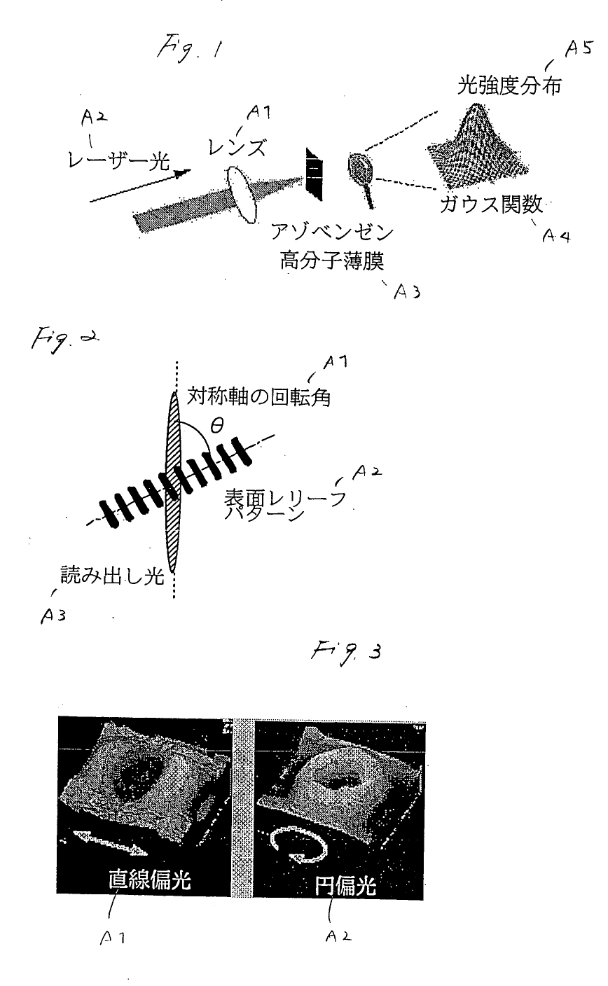

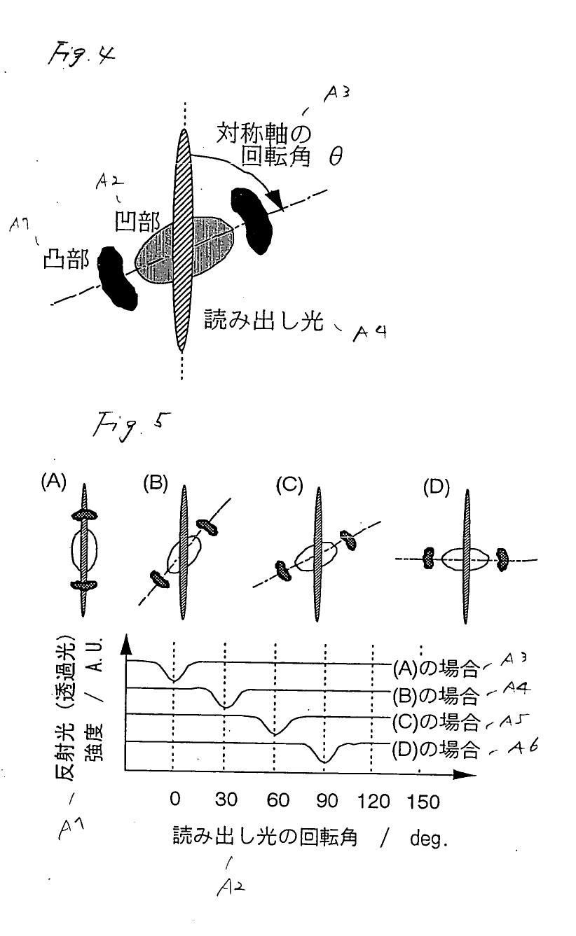

When a thin film of an azobenzene polymer is irradiated with a linearly polarized laser beam through a condenser as shown in FIG. 1, a surface relief pattern characterized by one central depression (pit) and two portions which have a characteristic rise with respect to the direction of electric field vector of linear polarization is formed on the thin film as shown in FIG. 3.

Then, a surface relief pattern the symmetric axis of which has rotated by θ as shown in the typical diagram of FIG. 4 is irradiated with reading light having a line width as small as pit, and the transmitted light or reflected light is monitored. As reading light rotates, the intensity of transmitted light or reflected light increases or decreases, and since the change of the intensity of transmitted light or reflected light is not smaller than the actual detection sensitivity, the position θ of the symmetric axis of surface relief pattern can be detected as shown in FIG. 5.

Accordingly, the number (m) of data codes having arbitrary number of divisions can be distinguished depending on the difference of position θ of symmetric axis (angle gradient multiplexed recording) unlike the prior art system in which one pit merely has a two-value such as 0 (having no pit) and 1 (having pit) . For example, when the orientation of unevenness is changed stepwise by 30 degrees as shown in FIG. 4, the number of data codes (including those free of pit) which can be supported by one pit is 7, making it possible to attain a recording density as much as 7 times that of the conventional recording. By reducing further the graduation of angle (φ), the number m of data codes can be raised to (180/φ+1).

Further, since it is thought that the absolute value of reflectance or transmittance changes with the depth of pit (see FIG. 6), they can be distinguished by reflectance (or transmittance). Accordingly, supposing that the number of gradations of depth is n, the number of data codes rises as n^{m} .

### Embodiment 2

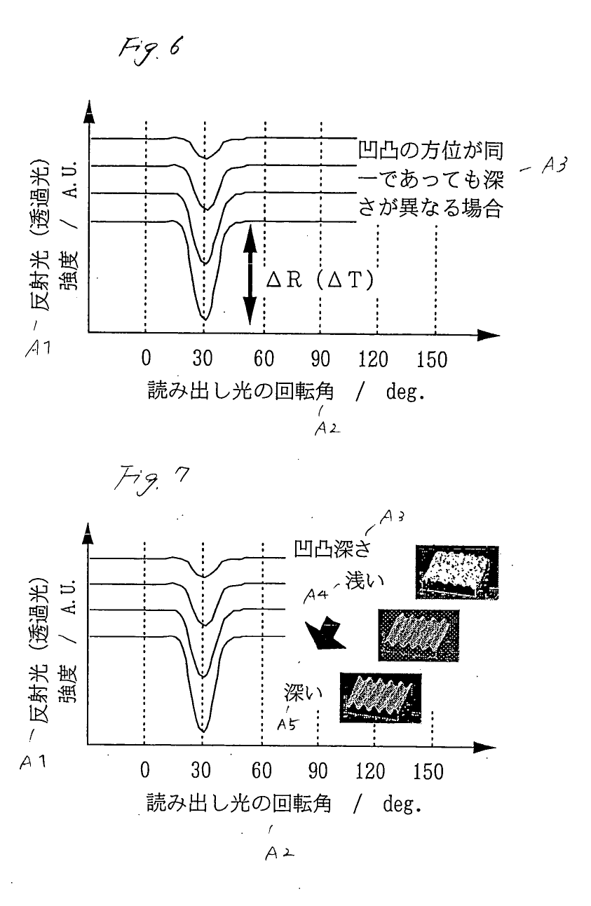

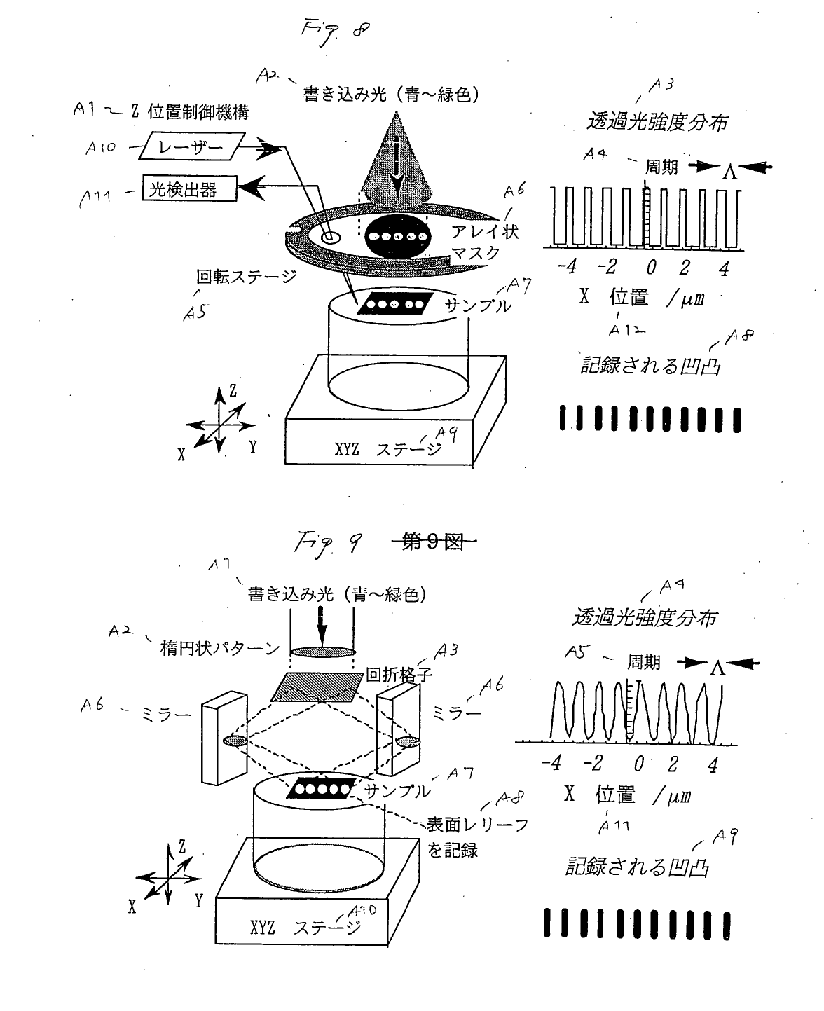

When a thin film of an azobenzene polymer is irradiated with an ellipsoidal (or rectangular) light pattern having a periodical distribution of light intensity (i.e., band of light and darkness) as shown in FIG. 2, a surface relief pattern having fallen portions by a number of k and raised portions by a number of (k+1) arranged alternately in a straight line is obtained on the thin film as shown in FIG. 7.

The ellipsoidal (or rectangular) light pattern having a periodical distribution of light intensity (i.e., band of light and darkness) as shown in FIG. 2 can be easily produced in an optical system including a photomask (FIG. 8) or an optical system utilizing light interference (FIG. 9). (However, the present invention is not limited to these systems.)

When the surface relief pattern thus obtained is subjected to reading in the same manner as in Example 1, the rise or drop of the intensity of transmitted light or reflected light can be detected as a function of rotation of reading light. During this process, the signal-to-noise ratio is raised to several times to scores of times that of Example 1 due to the rise of the number of fallen and raised portions on the surface. The present example allows depth gradation multiplexed recording in addition to angle gradation multiplexed recording similarly to Example 1, and in this case, too, a higher signal-to-noise ratio is obtained.

### INDUSTRIAL APPLICABILITY

In accordance with the present application, despite the use of the same medium as in the conventional case, a recording density higher than that of the conventional data recording can be atttained.

1. A data recording/reproducing method utilizing a pattern having an anisotropy formed by irradiating a thin polymer film having an azobenzene site with light,
the data recording/reproducing method comprising the steps of:
forming a surface relief pattern having a fallen portion and a raised portion arranged alternately in a straight line,
controlling the angle of rotation of the straight line, and
recording and reproducing a plurality of data based on the angle of rotation.

2. The data recording/reproducing method as described in claim 1, wherein
depth data by the difference of depth in the pattern are added.

3. The data recording/reproducing method as described in claim 1, wherein
the pattern has fallen portions by a nuber of k and raised portions by a number of (k+1) (k is a positive integer of 0 or more).

4. The data recording/reproducing method as described in claim 1, wherein
the raised portions by a number of (k+1) are arranged alternately in a straight line with the fallen portions by a number of k interposed therebetween, respectively.

5. A data recording medium which utilizes a pattern having an anisotropy formed by irradiating a thin polymer film having an azobenzene site with light, wherein
a surface relief pattern having a fallen portion and a raised portion arranged alternately in a straight line is formed, and
the angle of rotation of the straight line is controlled, and
a plurality of data based on the angle of rotation are recorded and reproduced.

6. The data recording medium as described in claim 5, wherein depth data by the difference of depth in the pattern are added.

7. The data recording medium as described in claim 5, wherein a large number of the patterns are formed.

8. The data recording medium as described in claim 5, wherein
the pattern has fallen portions by a number of k and raised portions by a number of (k+1).

9. The data recording medium as described in claim 5, wherein
the raised portions by a number of (k+1) are arranged alternately in a straight line with the fallen portions by a number of k interposed therebetween, respectively.
